(19) United States
(12) Patent Application Publication
(10) Pub. No.: US 2026/0318724 A1
(43) Pub. Date: Oct. 15, 2026

(54) TRANSDUCER CONNECTION FOR AN ULTRASONIC FLOW METER

(71) Applicant: MICRO MOTION, INC., Boulder, CO (US)

(72) Inventors: Daniel A. MILLER, Denver, CO (US); Bharat Bajirao PAWAR, Miraj, Maharashtra (IN)

(73) Assignee: MICRO MOTION, INC., Boulder, CO (US)

(21) Appl. No.: 19/486,298

(22) PCT Filed: May 31, 2023
(86) PCT No.: PCT/US2023/023938

§ 371 Date: Nov. 20, 2025

(51) Int. Cl. G01F 1/66; G01F 1/667; G01F 15/18

(52) U.S. Cl. CPC G01F 1/662; G01F 1/667; G01F 15/18

(57) ABSTRACT

A transducer assembly (108) for an ultrasonic flow meter (100) is provided. A transducer cable (126) has a connector (300) attached thereto. A capsule retainer (304) is coupleable to the connector (300). A retaining element (310) is engagable to the connector (300) and the capsule retainer (304) is configured to prevent the connector (300) from uncoupling from the capsule retainer (304), wherein the retaining element (310) at least partially circumscribes the connector (300).

### TECHNICAL FIELD

The embodiments described below relate to ultrasonic flow meters and, more particularly, to transducer assemblies employed in ultrasonic flow meters.

### BACKGROUND OF THE INVENTION

Ultrasonic flow meters generally include two or more transducer assemblies, each secured inside of a port in the body, or spool piece, of the flow meter. This connection is fluid-tight. The spool piece and end connectors therefore create a pressure boundary that contains fluid flowing through the meter.

To measure fluid flow through the meter, a first and a second transducer assembly arc positioned in a port in the spool piece, such that each transducer assembly is opposed one another. Each transducer assembly generally includes a piezoelectric element or similar portion. When an alternating current is applied to the piezoelectric element of the first transducer assembly, the piezoelectric element responds by radiating an ultrasonic wave in the fluid being transported through the flow meter. When the wave is incident upon the piezoelectric element of the second transducer assembly, the second transducer assembly responds by generating an electric signal. At a later time point, an alternating current is applied to the piezoelectric element of the second transducer assembly, and the piezoelectric element responds by radiating an ultrasonic wave through the fluid in the flow meter. When the wave is incident upon the piezoelectric element of the first transducer assembly, the first transducer assembly responds by generating an electric signal. In this way, the transducer assemblies transmit and receive signals back-and-forth across the fluid stream.

Each transducer assembly is connected to a cable that extends through the end connector to a location external to the spool piece, such as an electronics base enclosure typically mounted to the exterior of the spool piece. The cable carries the signals created by the piezoelectric elements to an acquisition board positioned within the electronics base enclosure, where the signal may be processed and subsequently used to determine the fluid flow rate through the meter.

The transducer cable must be fastened to the transducer in some manner to ensure the connector does not become inadvertently disconnected during transportation or unintentional forces placed thereupon.

FIGS. 1 and 2 illustrate a prior art approach to retaining the transducer cable 50 to the transducer housing 52. A connector 54 of the transducer cable 50 is secured to the transducer housing 52 using hitch pins 56 inserted into a capsule retainer 58 disposed at a rear distal portion 60 of the assembly. Once the transducer cable connector 54 is attached to the capsule retainer 58, one or more hitch pins 56 are inserted into holes 62 defined by the capsule retainer 58. The holes 62 align with grooves 64 in the connector 54, enabling the hitch pins 56 to pass through the space defined by the grooves 64, thus preventing the connector 54 from removal from the capsule retainer 58.

An issue related to this and similar connection means between the transducer cable 50 and transducer housing 52 is the reliance on relatively small pieces of hardware that are prone to being lost. Such small pieces of hardware, such as hitch pins, snap rings, and the like are also prone to being mis-shaped with repeated use.

A transducer housing and cable attachment device and related method are provided. The embodiments described below overcome these and other problems and an advance in the art is achieved. The embodiments provide a robust, fast, and secure connection for the transducer cable that can be easily uninstalled without removing tiny pieces of easily lost or damaged hardware.

### SUMMARY OF THE INVENTION

A transducer assembly for an ultrasonic flow meter is provided according to an embodiment. The transducer assembly comprises a transducer cable having a connector attached thereto and a capsule retainer coupleable to the connector. A retaining element is engagable to the connector and the capsule retainer is configured to prevent the connector from uncoupling from the capsule retainer, wherein the retaining element at least partially circumscribes the connector.

A method for assembling a transducer assembly for an ultrasonic flow meter is provided according to an embodiment. The method comprises providing a transducer cable having a connector attached thereto, providing a capsule retainer coupleable to the connector, and coupling the connector to the capsule retainer. A retaining element is coupled to the capsule retainer. The connector is at least partially circumscribed with the retaining element. The connector is prevented, with the retaining element, from uncoupling from the capsule retainer.

### ASPECTS

According to an aspect, a transducer assembly for an ultrasonic flow meter comprises a transducer cable having a connector attached thereto and a capsule retainer coupleable to the connector. A retaining element is engagable to the connector and the capsule retainer is configured to prevent the connector from uncoupling from the capsule retainer, wherein the retaining element at least partially circumscribes the connector.

Preferably, at least one fastener that passes through a slot defined by the retaining element, and is securable to the capsule retainer.

Preferably, a head of the fastener is larger than at least a portion of the slot, and is configured to engage a face of the retaining element to exert a force and secure the retaining element to the capsule retainer.

Preferably, the retaining element is removable from the capsule retainer without removing the at least one fastener.

Preferably, the retaining element is rotatable about the connector.

Preferably, the retaining element is rotatable about the connector, and the slot rotatably and slidingly moves about the fastener.

Preferably, the retaining element engages a lip of the connector.

Preferably, the capsule retainer comprises a bore, and the connector is at least partially placeable in a bore.

Preferably, the retaining element comprises an opening configured to allow a cable to pass therethrough, such that the installation of the retaining element is possible when the connector is engaged to the capsule retainer.

Preferably, the slot comprises a keyhole-style slot.

According to an aspect, a method for assembling a transducer assembly for an ultrasonic flow meter comprises providing a transducer cable having a connector attached thereto, providing a capsule retainer coupleable to the connector, and coupling the connector to the capsule retainer. A retaining element is coupled to the capsule retainer. The connector is at least partially circumscribed with the retaining element. The connector is prevented, with the retaining element, from uncoupling from the capsule retainer.

Preferably, the method comprises forming a slot in the retaining element and securing the retaining element to the capsule retainer with at least one fastener that passes through a slot.

Preferably, the method comprises providing a head on the fastener being larger than at least a portion of the slot and securing the retaining element to the capsule retainer by exerting a force on a face of the retaining element with the head of the fastener.

Preferably, the method comprises configuring the retaining element to be removable from the capsule retainer without removing the at least one fastener.

Preferably, the method comprises rotating the retaining element about the connector.

Preferably, the method comprises rotating the retaining clement about the connector and rotatably and slidingly engaging the slot about the fastener.

Preferably, the method comprises engaging a lip of the connector with the retaining element.

Preferably, the method comprises forming a bore in the capsule retainer and placing the connector at least partially in the bore.

Preferably, the method comprises forming an opening in the retaining element configured to allow a cable to pass therethrough to reside in a center aperture of the retaining element, wherein the opening breaks a perimeter of the retaining element, and installing the retaining element on the capsule retainer while the connector is engaged to the capsule retainer.

Preferably, the slot comprises a keyhole-style slot.

### BRIEF DESCRIPTION OF THE DRAWINGS

FIG. 1 shows a prior art transducer housing;

FIG. 2 shows a cross section of the prior art transducer housing of FIG. 1;

FIG. 3 shows an ultrasonic flow meter according to an embodiment;

FIG. 4 shows a cross-sectional overhead view of the ultrasonic flow meter shown in FIG. 3;

FIG. 5 shows an end elevation view of the ultrasonic flow meter shown in FIG. 3;

FIG. 6 illustrates a transducer assembly according to an embodiment;

FIG. 7 illustrates the transducer assembly of FIG. 6 in the unlocked position;

FIG. 8 illustrates an exploded view of the transducer assembly of FIG. 6; and

FIG. 9 illustrates a retaining element according to an embodiment.

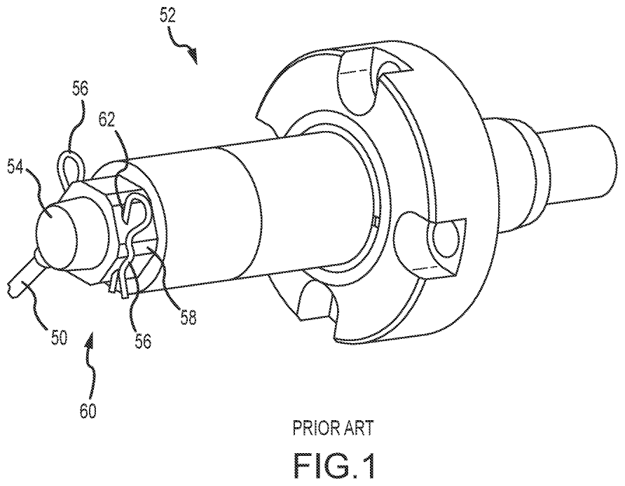

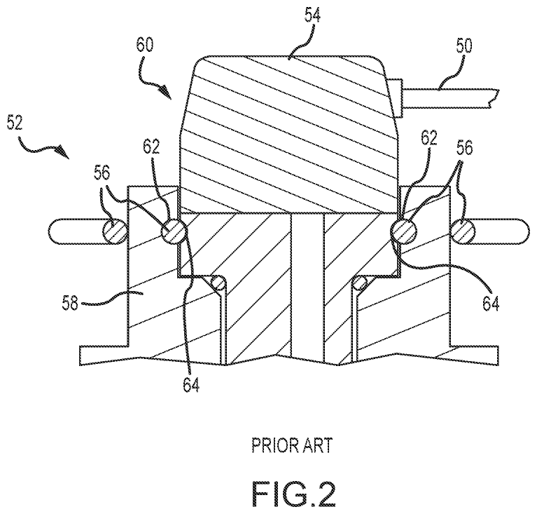

### DETAILED DESCRIPTION OF THE INVENTION

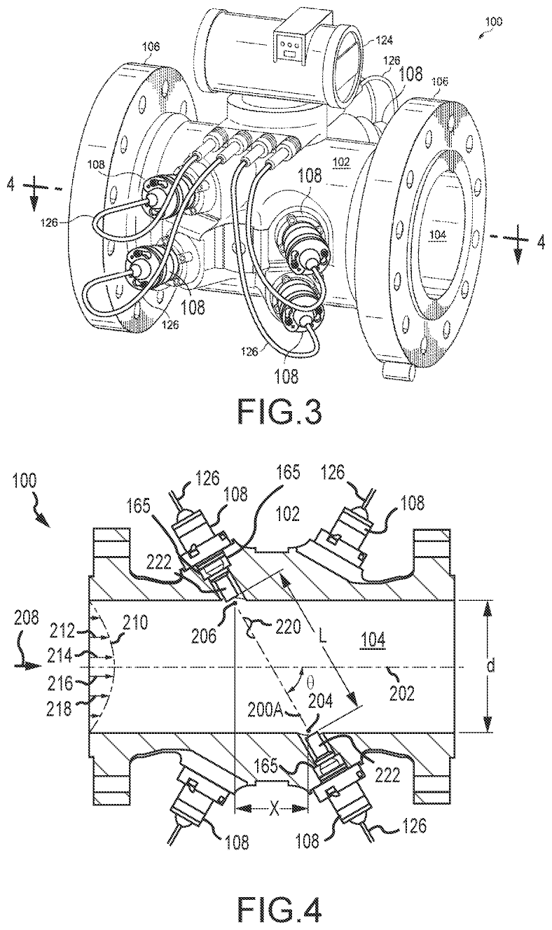

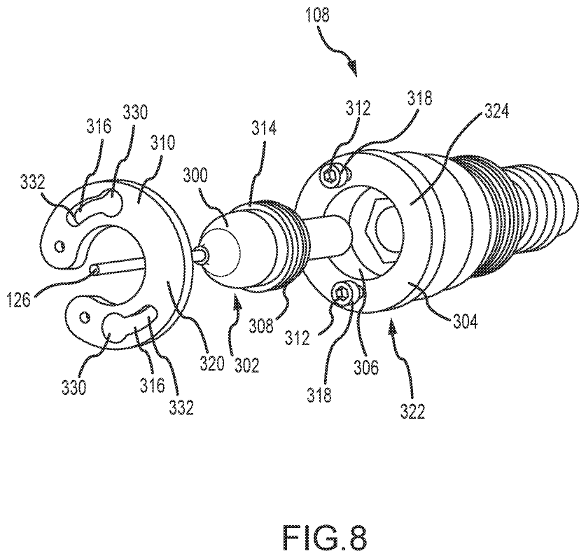

FIGS. 3-9 and the following description depict specific examples to teach those skilled in the art how to make and use the best mode of embodiments of a transducer housing and related cable connection. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of embodiments. As a result, the embodiments described below are not limited to the specific examples described below, but only by the claims and their equivalents.

FIG. 3. illustrates an ultrasonic flow meter 100 in accordance with principles disclosed herein. The ultrasonic flow meter 100 includes a meter body or spool piece 102 that defines a central bore or passage 104. The spool piece 102 is designed and constructed to be coupled to a pipeline or other structure (not shown) carrying fluids (e.g., liquids, gases, mixed-phase materials) such that the fluids flowing in the pipeline travel through the central passage 104. While the fluids travel through the central passage 104, the ultrasonic flow meter 100 measures the flow rate; hence, the fluid may be referred to as the measured fluid. The spool piece 102 includes flanges 106 that facilitate coupling of the spool piece 102 to another structure. In other embodiments, any suitable system for coupling the spool piece 102 to a structure may be equivalently used (e.g., weld connections).

In order to measure fluid flow within the spool piece 102, the ultrasonic flow meter 100 includes a plurality of transducer assemblies 108. In the view of FIG. 3, five such transducer assemblies 108 are in view. The transducer assemblies are paired, as will be further discussed below. Moreover, each transducer assembly is electrically coupled to the control electronics package 124 by way of a respective cable 126 or an equivalent signal conducting assembly or wireless communication method.

FIG. 4 shows a cross-sectional overhead view of the ultrasonic flow meter 100 taken substantially along line 4-4 of FIG. 3. Spool piece 102 has a predetermined size and defines the central passage 104 through which the measured fluid flows. An illustrative pair of transducer assemblies 108 is located along the length of spool piece 102. Transducer assemblies 108 include acoustic transceivers, and more particularly include ultrasonic transducer assemblies operating alternately as a transmitter and receiver. The ultrasonic transducer assemblies 108 both generate and receive acoustic signals having frequencies above about 20 kilohertz. The acoustic signals may be generated and received by a piezoelectric element in each transducer assembly 108. To generate an ultrasonic signal, the piezoelectric element is stimulated electrically by way of a signal (e.g., a periodic signal) transmitted through cable 126, and the element responds by vibrating. The vibration of the piezoelectric element generates the acoustic signal that travels through the measured fluid to the corresponding transducer assembly of the pair. Similarly, upon being struck by an acoustic signal, the receiving piezoelectric element vibrates and generates an electrical signal (e.g., a sinusoidal signal) that is detected, digitized, and analyzed by the electronics associated with the flow meter 100 (e.g., the control electronics 124). With continuing to reference FIG. 4, a path 200A, also referred to as a “chord,” exists between illustrative transducer assemblies 108 at a non-perpendicular angle θ (theta) to a central bore centerline 202. The length of chord 200A is the distance L between the face of transducer assembly 108 and the face of opposing transducer assembly 108. Points 204 and 206 define the locations where acoustic signals generated by transducer assemblies 108 enter and leave fluid flowing through the spool piece 102. The position of transducer assemblies 108 may be defined by the angle θ, by the cord length L measured between the faces of the transducer assemblies 108, a second length X corresponding to the axial distance between points 204 and 206, and a third length d corresponding to the pipe inside diameter. In most cases distances d, X, and L are precisely determined during flow meter fabrication. A measured fluid, such as natural gas, flows in a direction 208 with a velocity profile 210. Velocity vectors 212, 214, 216 and 218 illustrate that the gas velocity through spool piece 102 increases toward the centerline 202 of the spool piece 102.

Initially, a downstream transducer assembly 108 generates an ultrasonic signal that is incident upon, and thus detected by, upstream opposing transducer assembly 108. Sometime later, the upstream transducer assembly 108 generates a return ultrasonic signal that is subsequently incident upon, and detected by, the downstream transducer assembly 108. Thus, the transducer assemblies exchange or play “pitch and catch” with ultrasonic signals 220 along chordal path 200A. During operation, this sequence may occur thousands of times per minute.

The transit time of an ultrasonic signal 220 between illustrative transducer assemblies 108 depends in part upon whether the ultrasonic signal 220 is traveling upstream or downstream with respect to the fluid flow. The transit time for an ultrasonic signal traveling downstream (i.e., in the same direction as the fluid flow) is less than its transit time when traveling upstream (i.e., against the fluid flow). The upstream and downstream transit times can be used to calculate the average velocity along the flow path, and the speed of sound in the measured fluid. Given the cross-sectional measurements of the flow meter 100 carrying the fluid, the average velocity over the arca of the central passage 104 may be used to find the volume of fluid flowing through the spool piece 102.

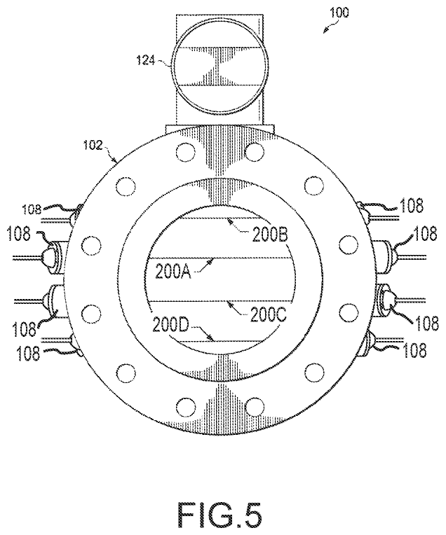

Ultrasonic flow meters can have one or more chords, e.g., one chord for each pair of facing transducer assemblies. FIG. 5 illustrates an end elevation view of ultrasonic flow meter 100. In particular, illustrative ultrasonic flow meter 100 comprises four chordal paths 200A, 200B, 200C and 200D at varying elevations within the spool piece 102. Each chordal path 200A-D corresponds to a transducer pair operating alternately as a transmitter and receiver. As explained with respect to FIG. 4, each pair of transducer assemblies 108 defines a chordal path 200A, path 200B, 200C, and 200D.

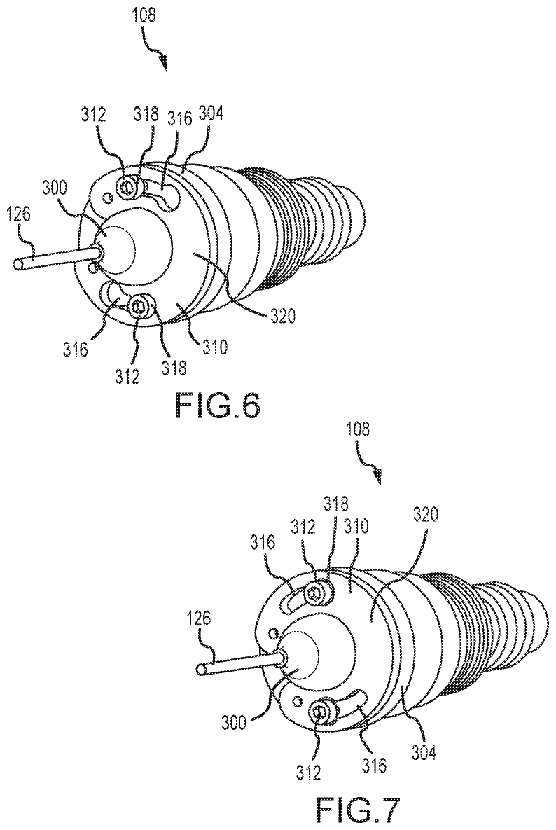

FIGS. 6-8 disclose a portion of the transducer assembly 108 that couples to and/or within the transducer ports (e.g., 165 of FIG. 4). In particular, the assembly 108 comprises a transducer cable 126 attached thereto. The transducer cable 126 comprises a connector 300 on a distal end 302 thereof. The transducer cable 126, and in particular the connector 300, couple to a capsule retainer 304.

The connector 300 fits inside a bore 306 defined by the capsule retainer 304. A seal 308, such as an O-ring for example and without limitation, may provide a seal against fluids and any other matter otherwise deemed as foreign from entering interior portions of the transducer assembly 108. More than one sealing means may be present.

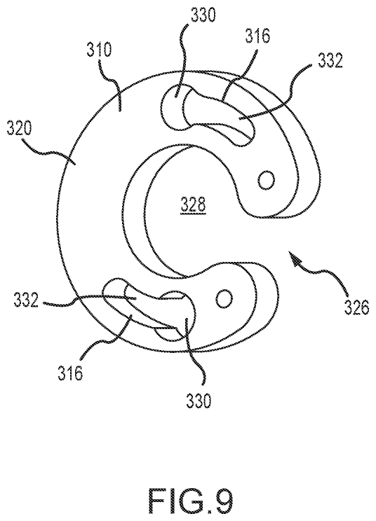

The connector 300 is coupled to the capsule retainer 304 with a retaining element 310. The retaining element 310 is illustrated in FIG. 9. The retaining element 310 engages a lip 314. When the connector 300 is placed into the bore 306, and the retaining element 310 is placed against a lip 314 of the connector 300, pressure by the retaining element 310 against the lip 314, and therefore the connector 300, causes the connector 300 to fully seat/couple/engage to the capsule retainer 304 upon fully seating the retaining element 310 against the capsule retainer 304. In this way, the connector 300 is prevented from uncoupling from the capsule retainer 304.

In order to fully seat the retaining element 310 against the capsule retainer 304, fasteners 312 may be used, as will be understood by those skilled in the art. In an embodiment, the retaining element 310 comprises a slot 316 that allows a fastener 312, such as a bolt or screw for example, to partially pass through, such that a head 318 of the fastener 312 engages a face 320 of the retaining clement 310 and secures the retaining element 310 to a face 324 of the capsule retainer 304 situated at a distal end 322 of the capsule retainer 304.

The retaining element 310 may be made from metal, ceramic, composite, polymer, or any other appropriate material known in the art.

As illustrated, retaining element 310 comprises an opening 326 that allows the transducer cable 126 to pass therethrough so that the retaining element 310 may be installed without the need to thread the opposite end of the transducer cable 126 through the center aperture 328 of the retaining element 310 or to disengage the connector 300 from the capsule retainer 304. The opening 326, in some embodiments, is a break in the perimeter of the retaining element that allows access to the center aperture 328. Furthermore, this allows installation of the retaining element 310 if both ends of the transducer cable 126 have connectors or otherwise have ends that are larger than the center aperture 328 of the retaining element 310. This also allows installation of the retaining element 310 even if the connector 300 is engaged to the capsule retainer 304.

In an embodiment, however, the retaining element 310 is closed off such that there is no opening 326. In each embodiment, the retaining element 310 at least partially circumscribes the connector 300.

As illustrated, retaining element 310 comprises a C-shaped ring that acts as a collar around the connector 300, and it fastens the connector 300 to the capsule retainer 304 using a pair of fasteners 312 that, in some embodiments, are threaded and removable. The slot 316 may be a keyhole-style slot, as illustrated, such that a fastener head 318 may pass through an enlarged region 330 of the slot 316 upon installation of the retaining element 310 over the fasteners 312, and onto the capsule retainer 304. By rotating the retaining element 310 after the fastener head 318 has cleared the enlarged region 330, the retaining element 310 is positioned such that a portion of the fastener 312 having a smaller cross-sectional radius than the head 318 (not visible) protrudes through a constricted portion 332 of the slot 316, and the slot rotatingly and slidingly moves about the fastener 312. By securing/tightening the fastener 312 when the retaining element 310 is in this position, the head 318 of the fastener engages the face 320 of the retaining element 310. This secures the retaining element 310 to the capsule retainer 304. In an embodiment, the retaining element 310 engages a lip 314 of the connector 300, which in turn exerts a force on the lip 314 of the connector 300, thus securing the connector 300 in place.

In this manner, installation and removal of the retaining element 310 can be accomplished without removing the fasteners 312 from the capsule retainer 304, thus reducing the likelihood of losing the fasteners 312 or damaging the capsule retainer 304, such as by cross-threading, for example. It should be noted that more or less than two fasteners 312 may be used. It should be noted that more or less than two slots 316 may be defined by the retaining element 310.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description. Thus, although specific embodiments of, and examples for, the transducer assembly are described herein for illustrative purposes, various equivalent modifications are possible within the scope of the present description, as those skilled in the relevant art will recognize. The teachings provided herein can be applied to other sensor assemblies, and not just to the embodiments described above and shown in the accompanying figures.

Accordingly, the scope of the embodiments described above should be determined from the following claims.

We claim:

1. A transducer assembly (108) for an ultrasonic flow meter (100), comprising:
a transducer cable (126) having a connector (300) attached thereto;
a capsule retainer (304) coupleable to the connector (300);
a retaining element (310) engagable to the connector (300) and the capsule retainer (304) configured to prevent the connector (300) from uncoupling from the capsule retainer (304), wherein the retaining element (310) at least partially circumscribes the connector (300).

2. The transducer assembly (108) of claim 1, comprising at least one fastener (312) that passes through a slot (316) defined by the retaining element (310), and is securable to the capsule retainer (304).

3. The transducer assembly (108) of claim 2, wherein a head (318) of the fastener (312) is larger than at least a portion of the slot (316), and is configured to engage a face (320) of the retaining element (310) to exert a force and secure the retaining element (310) to the capsule retainer (304).

4. The transducer assembly (108) of claim 2, wherein the retaining element (310) is removable from the capsule retainer (304) without removing the at least one fastener (312).

5. The transducer assembly (108) of claim 2, wherein the retaining element (310) is rotatable about the connector (300).

6. The transducer assembly (108) of claim 3, wherein the retaining element (310) is rotatable about the connector (300), and the slot (316) rotatably and slidingly moves about the fastener (312).

7. The transducer assembly (108) of claim 1, wherein the retaining element (310) engages a lip (314) of the connector (300).

8. The transducer assembly (108) of claim 1, wherein the capsule retainer (304) comprises a bore (306), and the connector (300) is at least partially placeable in a bore (306).

9. The transducer assembly (108) of claim 1, wherein the retaining element (310) comprises an opening (326) configured to allow a cable (126) to pass therethrough, such that the installation of the retaining element (310) is possible when the connector (300) is engaged to the capsule retainer (304).

10. The transducer assembly (108) of claim 2, wherein the slot (316) comprises a keyhole-style slot.

11. A method for assembling a transducer assembly for an ultrasonic flow meter, comprising:
providing a transducer cable having a connector attached thereto;
providing a capsule retainer coupleable to the connector;
coupling the connector to the capsule retainer;
coupling a retaining element to the capsule retainer;
at least partially circumscribing the connector with the retaining element; and
preventing, with the retaining element, the connector from uncoupling from the capsule retainer.

12. The method of claim 11, comprising the steps of:
forming a slot in the retaining element; and
securing the retaining element to the capsule retainer with at least one fastener that passes through a slot.

13. The method of claim 12, comprising the steps of:
providing a head on the fastener being larger than at least a portion of the slot;
securing the retaining element to the capsule retainer by exerting a force on a face of the retaining element with the head of the fastener.

14. The method of claim 12, comprising the step of configuring the retaining element to be removable from the capsule retainer without removing the at least one fastener.

15. The method of claim 12, comprising the step of rotating the retaining element about the connector.

16. The method of claim 13, comprising the step of rotating the retaining element about the connector; and
rotatably and slidingly engaging the slot about the fastener.

17. The method of claim 11, comprising the step of engaging a lip of the connector with the retaining clement.

18. The method of claim 11, comprising the steps of:
forming a bore in the capsule retainer; and
placing the connector at least partially in the bore.

19. The method of claim 11, comprising the steps of:
forming an opening in the retaining element configured to allow a cable to pass therethrough to reside in a center aperture of the retaining element, wherein the opening breaks a perimeter of the retaining element; and
installing the retaining element on the capsule retainer while the connector is engaged to the capsule retainer.

20. The method of claim 11, wherein the slot comprises a keyhole-style slot.
